(19) United States
(12) Patent Application Publication
(10) Pub. No.: US 2006/0159171 A1
(43) Pub. Date: Jul. 20, 2006

(54) Buffer-adaptive video content classification

(76) Inventor: Nader Mohsenian, Lawrence, MA (US)

Correspondence Address: MCANDREWS HELD & MALLOY, LTD, 500 WEST MADISON STREET, SUITE 3400, CHICAGO, IL, 60661, US

(21) Appl. No.: 11/039,047

(22) Filed: Jan. 18, 2005

(51) Int. Cl. H04N 7/12

(52) U.S. Cl. 375/240.13

(57) ABSTRACT

Described herein is a video system with adaptive buffering comprising a video encoder and a motion estimator is presented. The motion estimator classifies content of one or more pictures. The video encoder allocates an amount of data for encoding another one or more pictures based on the content of the one or more pictures. The another one or more pictures follow the one or more pictures.

### RELATED APPLICATIONS

[Not Applicable]

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

Digital video encoders may use variable bit rate (VBR) encoding. VBR encoding can be performed in real-time or off-line. The transmission of real-time video is resource-intensive as it requires a large bandwidth. Efficient utilization of bandwidth will increase channel capacity, and therefore, revenues of video service providers will also increase.

VBR encoded video minimizes spatial and temporal redundancies to achieve compression and optimize bandwidth usage. To assist in achieving a Quality of Service (QoS), content classification is important. VBR encoding can achieve improved coding efficiency by better matching the encoding rate to the video complexity and available bandwidth if the motion in a scene can be predicted. Therefore, a need exists for a system and method to realize content classification in variable bit-rate video encoders. Content classification can enable more graceful QoS transitions from scene to scene.

### BRIEF SUMMARY OF THE INVENTION

Described herein are video system with adaptive buffering s and method(s) for classifying video data.

In one embodiment of the invention, a video system with adaptive buffering comprising a video encoder and a motion estimator is presented. The motion estimator classifies content of one or more pictures. The video encoder allocates an amount of data for encoding another one or more pictures based on the content of the one or more pictures. The another one or more pictures follow the one or more pictures.

In another embodiment, a method for adapting video buffers is presented. Content for one or more pictures is classified. Then, an amount of data for encoding another one or more pictures is allocated based on the content of the one or more pictures.

In another embodiment, a circuit comprising a processor and a memory is presented. The memory is connected to the processor and stores a plurality of instructions executable by the processor. The execution of said instructions causes video buffers to be adapted as described in the method above.

These and other advantages and novel features of the present invention, as well as illustrated embodiments thereof, will be more fully understood from the following description and drawings.

### BRIEF DESCRIPTION OF THE DRAWINGS

FIG. 1 is a block diagram of an exemplary video system with adaptive buffering in accordance with an embodiment of the present invention;

FIG. 2 is another block diagram of an exemplary video system with adaptive buffering in accordance with an embodiment of the present invention;

FIG. 3 is a flow diagram of an exemplary method for classifying video in accordance with an embodiment of the present invention; and

FIG. 4 is another flow diagram of an exemplary method for classifying video in accordance with an embodiment of the present invention.

### DETAILED DESCRIPTION OF THE INVENTION

According to certain aspects of the present invention, a video system with adaptive buffering and method of adapting video buffers optimizes bandwidth allocation according to picture type, and optimized bandwidth allocation will improve video quality.

Most video applications require the compression of digital video for transmission, storage, and data management. The task of compression is accomplished by a video encoder. The video encoder minimizes spatial, temporal, and spectral redundancies to achieve compression. Removal of temporal redundancies is effective in producing the least amount of data information prior to actual compression. The task of exploiting temporal redundancies is carried out by the motion estimator of a video encoder. With few temporal discontinuities and a fair amount of consistent image detail, the encoder can afford to pre-classify the video content in terms of assigning certain amount of bits to various picture types. Various picture types are defined by exploiting spatial, temporal, or both spatial and temporal redundancies. Digital video may contain many dissimilar scenes. Some are fast moving, some are static, and others are in between.

Typically, video encoders are stressed by temporal changes and need react appropriately. The reaction should be comprised of graceful quality transition from one scene to another. Therefore, content classification is very important. Content classification may be defined by labeling the scene as fast moving, pure static, pseudo-static, slowly-moving etc . . . . Using stored buffer occupancy masks, actual buffer occupancy of an encoder device can be classified.

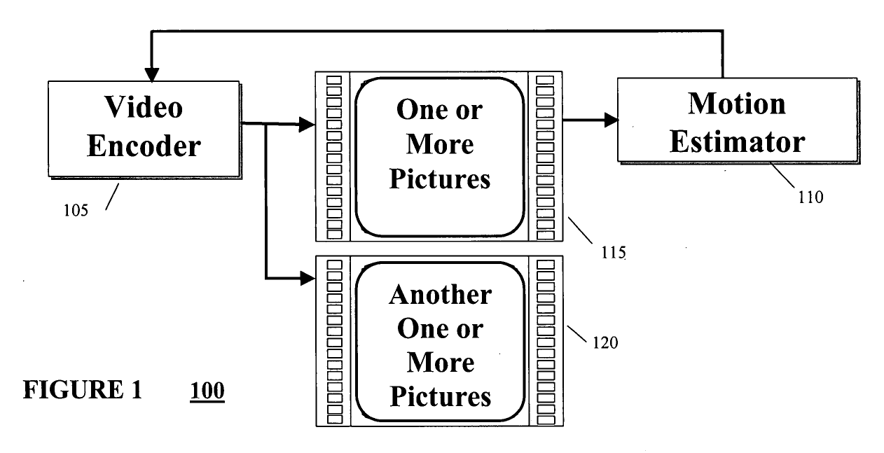

In FIG. 1, a video system with adaptive buffering 100 comprising a video encoder 105 and a motion estimator 110 is presented. The video encoder 105 encodes one or more pictures 115. The motion estimator 110 classifies content of the one or more pictures 115 and sends that classification back to the video encoder 105. The video encoder 105 allocates an amount of data for encoding another one or more pictures 120 based on the content of the one or more pictures 115. The another one or more pictures 120 follow the one or more pictures 115.

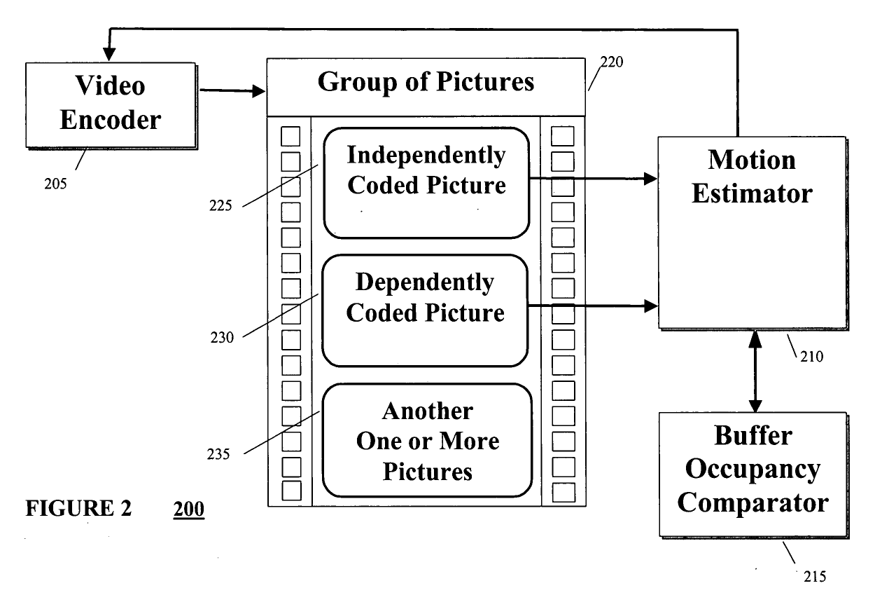

In FIG. 2, another video system with adaptive buffering 200 comprising a video encoder 205, a buffer occupancy comparator 215, and a motion estimator 210 is presented. The video encoder 205 encodes a first picture independently and encodes a second picture dependently to generate an independently coded picture 225 and a dependently coded picture 230 respectively. The independently coded picture 225 is comprised of a first number of bits and the dependently coded picture 230 is comprised of a second number of bits. The buffer occupancy comparator 215 compares the first number of bits to a first reference and compares the second number of bits to a second reference to generate an independency metric and a dependency metric respectively. The motion estimator 210 selects a scene classification based on the independency metric and dependency metric. The scene classification is sent to the video encoder 205. Based on the scene classification, another one or more pictures 235 is encoded. Typically, the independently coded picture 225, the dependently coded picture 230, and the another one or more pictures 235 will be labeled as a Group of Pictures 220 (GOP).

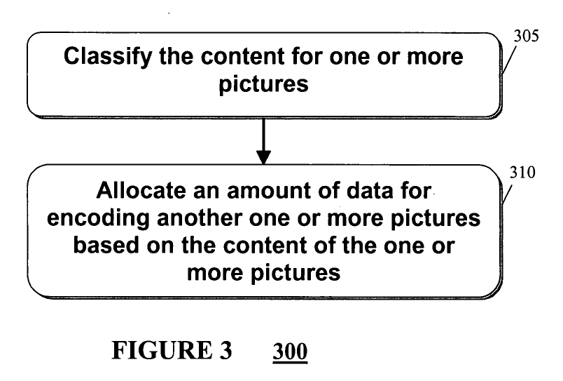

In FIG. 3, a method for classifying encoded video 300 is presented. Content for one or more pictures is classified 305. Then, an amount of data for encoding another one or more pictures is allocated based on the content of the one or more pictures 310.

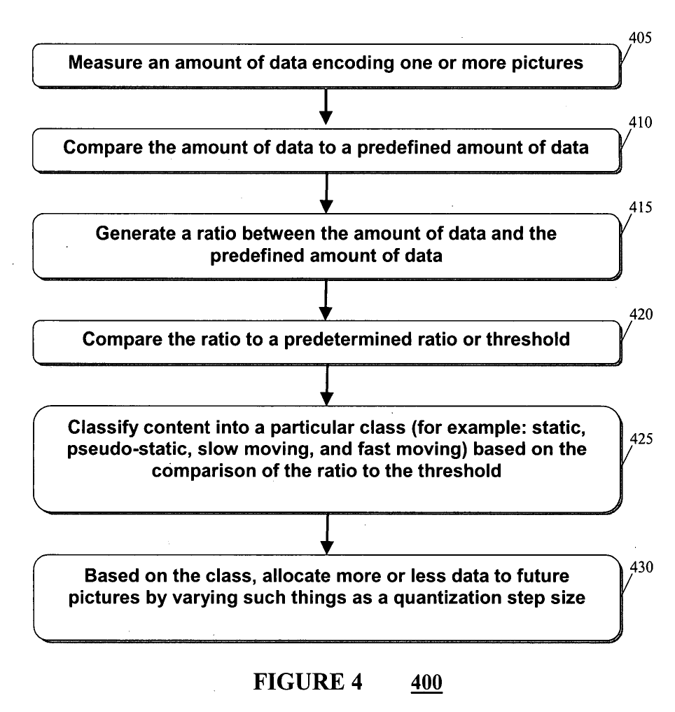

In FIG. 4, another method for classifying encoded video 400 is presented. An amount of data encoding one or more pictures is measured 405. The amount of data is compared to a predefined amount of data 410. A ratio between the amount of data and the predefined amount of data is generated 415. The ratio is compared to a predetermined ratio or threshold 420. Content is classified into a particular class (for example: static, pseudo-static, slow moving, and fast moving) based on the comparison of the ratio to the threshold 425. Based on the class, more or less data is allocated to future pictures by varying such things as a quantization step size 430.

Exemplary digital video encoding has been standardized by the Moving Picture Experts Group (MPEG). One such standard is the ITU-H.264 Standard (H.264). H.264 is also known as MPEG-4, Part 10, and Advanced Video Coding. In the H.264 standard video is encoded on a picture by picture basis, and pictures are encoded on a macroblock by macroblock basis. H.264 specifies the use of spatial prediction, temporal prediction, transformation, interlaced coding, and lossless entropy coding to compress the macroblocks. The term picture is used throughout this specification to generically refer to frames, fields, macroblocks, or portions thereof.

Using the MPEG compression standards, video is compressed while preserving image quality through a combination of spatial and temporal compression techniques. An MPEG encoder generates three types of coded pictures: Intra-coded (I), Predictive (P), and Bi-directional (B) pictures. An I picture is encoded independently of other pictures based on a Discrete Cosine Transform (DCT), quantization, and entropy coding. I pictures are referenced during the encoding of other picture types and are coded with the least amount of compression. P picture coding includes motion compensation with respect to the previous I or P picture. A B picture is an interpolated picture that requires both a past and a future reference picture (I or P). The picture type I uses the exploitation of spatial redundancies while types P and B use exploitations of both spatial and temporal redundancies. Typically, I pictures require more bits than P pictures, and P pictures require more bits than B pictures. After coding, the frames are arranged in a deterministic periodic sequence, for example “IBBPBB” or “IBBPBBPBBPBB”, which is called Group of Pictures (GOP).

In FIG. 2, the independently coded picture 225 can be coded as an I picture and come first in a GOP 220. The independently coded picture 225 and the dependently coded picture 230 may also be the first pictures in a scene. The classification of motion by the motion estimator 210 at the beginning of a scene is an estimate of the motion during a scene. This estimate is passed to the video encoder 205 in order to adjust an allocation of bits among picture types based on the scene classification.

As an example of scene classification, a first class may be static and a second class may be fast moving. If a scene is comprised of at least one independently coded picture and at least one dependently coded picture, the motion estimate will be directly related to the size of the independently and dependently coded pictures. In a static scene, there is a great deal of temporal redundancy that is removed by the video encoder, but in a fast moving scene, pictures will change significantly over time. Assume that the static scene is given exactly the same number of bits (same bandwidth) as the fast moving scene. For the best quality, an independently coded picture in the static scene would be allocated more bits than an independently coded picture in the fast moving scene. Likewise, a dependently coded picture in the static scene would be allocated less bits than a dependently coded picture in the fast moving scene. With quality and bandwidth requirements held constant, speed in a scene is proportional to the relative size of dependently coded pictures and inversely proportional to the relative size of independently coded pictures.

Referring to the buffer occupancy comparator 215 of FIG. 2 and elements 410 of FIG. 4, there exists a number of bits measuring the size of the independently coded picture 225 and the dependently coded picture 230. There also exists reference sizes for coded pictures that are generated using a set bit-rate. A bit budget is used to obtain reference picture bits given a set of reference weights. The reference picture bits and set bit-rate determine the signature of a buffer mask.

Given a bit-rate of (BR) bits/sec and a picture-rate of (PR) pictures/sec, the number of bits in a 4 picture window would be:

Number of Bits (B)=(BR/PR)×4

An example weighting of I, P, and B pictures may be 4U, 2U, and U respectively, where U is a variable. A typical window of pictures at the beginning of a scene may be “I, P, B, B”. In terms of number of bits, this window can be described as “4U, 2U, U, U” or “B/2, B/4, B/8, B/8”.

In the buffer occupancy comparator 215 of FIG. 2, the size of the independently coded picture 225 and the dependently coded picture 230 are compared to the references. For the example above, the size of an independently coded I picture may be divided by a reference value of 4U to generate a ratio, and this ratio may be compared to a series of thresholds to generate an independency metric. For example, a ratio of more than 2.25 may be classified as static, a ratio between 1.5 and 2.25 may be classified as pseudo-static, a ratio between 0.75 and 1.0 may be classified as slow moving, and a ratio less than 0.75 may be classified as fast moving. In the same example, the size of a dependently coded P picture may be divided by a reference value of 2U to generate a second ratio, and this second ratio may be compared to another series of thresholds to generate a dependency metric. For example, a second ratio of less than 0.5 may be classified as static, a second ratio between 0.5 and 0.75 may be classified as pseudo-static, a second ratio between 0.75 and 1.33 may be classified as slow moving, and a second ratio greater than 1.33 may be classified as fast moving. This classification can be invoked after each scene change.

Accordingly, it is possible to generate several buffer masks based on a set of reference weights that are designed to correlate with video content classification. For example, we may have buffer mask 1, buffer mask 2 up to buffer mask N. These buffer masks may be labeled static, pseudo-static, slow moving, fast moving, etc . . . . When the actual buffer occupancy for a window results in strongest correlation with buffer mask n (1≦n≦N) then the new video content is declared class n.

It should be noted that a comparison of a picture's size to a reference size may take many forms; division and subtraction are a few ways of generating the comparison. Likewise, the size of the independently coded picture may be compared to the size of the dependently coded picture, and the result of this comparison can generate a motion estimate based on a reference comparison for a particular scene type.

The embodiments described herein may be implemented as a board level product, as a single chip, application specific integrated circuit (ASIC), or with varying levels of a video classification circuit integrated with other portions of the system as separate components.

The degree of integration of the video classification circuit will primarily be determined by the speed and cost considerations. Because of the sophisticated nature of modern processors, it is possible to utilize a commercially available processor, which may be implemented external to an ASIC implementation.

If the processor is available as an ASIC core or logic block, then the commercially available processor can be implemented as part of an ASIC device wherein certain functions can be implemented in firmware as instructions stored in a memory. Alternatively, the functions can be implemented as hardware accelerator units controlled by the processor.

Limitations and disadvantages of conventional and traditional approaches will become apparent to one of ordinary skill in the art through comparison of such systems with the present invention as set forth in the remainder of the present application with reference to the drawings.

While the present invention has been described with reference to certain embodiments, it will be understood by those skilled in the art that various changes may be made and equivalents may be substituted without departing from the scope of the present invention.

Additionally, many modifications may be made to adapt a particular situation or material to the teachings of the present invention without departing from its scope. For example, although the invention has been described with a particular emphasis on MPEG-4 encoded video data, the invention can be applied to a video data encoded with a wide variety of standards.

Therefore, it is intended that the present invention not be limited to the particular embodiment disclosed, but that the present invention will include all embodiments falling within the scope of the appended claims.

1. A method for adapting video buffers, said method comprising:
classifying content for one or more pictures; and
allocating an amount of data for encoding another one or more pictures based on the content of the one or more pictures, wherein the another one or more pictures follow the one or more pictures.

2. The method of claim 1, wherein the one or more pictures include:
an independently coded picture; and
a dependently coded picture.

3. The method of claim 1, wherein classifying content comprises:
measuring an amount of data encoding one or more pictures.

4. The method of claim 3, wherein classifying content comprises:
comparing the amount of data to a predefined amount of data.

5. The method of claim 4, wherein comparing comprises:
generating a ratio between the amount of data and the predefined amount of data.

6. The method of claim 5, wherein the content is based on the ratio.

7. The method of claim 6, wherein the ratio is compared to a predetermined ratio.

8. The method of claim 1, wherein allocating further comprises:
measuring an amount of data encoding a picture in the one or more pictures;
measuring another amount of data encoding another picture in the one or more pictures;
generating a ratio based on the amount of data and the another amount of data; and
classifying content for one or more pictures based on the ratio.

9. The method of claim 1, wherein allocating further comprises:
if the content is a first class, more data is allocated to an independently coded picture and less data is allocated to a dependently coded picture; and
if the content is a second class, less data is allocated to an independently coded picture and more data is allocated to a dependently coded picture.

10. The method of claim 1, wherein allocating comprises:
varying a quantization step size in the encoding of a picture in the another one or more pictures.

11. The method of claim 10, wherein varying further comprises:
increasing the quantization step size of the picture if the content is a first class and the picture is dependently coded; and
decreasing the quantization step size of the picture if the content is a second class and the picture is dependently coded.

12. The method of claim 1, wherein the content is one of a group of classes consisting of static, and pseudo-static, slow motion, and fast motion.

13. A video system with adaptive buffering comprising:
a motion estimator for classifying content of one or more pictures; and
a video encoder for allocating an amount of data for encoding another one or more pictures based on the content of the one or more pictures, wherein the another one or more pictures follow the one or more pictures.

14. The video system with adaptive buffering of claim 13, wherein the one or more pictures include:
an independently coded picture; and
a dependently coded picture.

15. The video system with adaptive buffering of claim 13 further comprising:
a buffer occupancy comparator for measuring an amount of data encoding one or more pictures.

16. The video system with adaptive buffering of claim 15, wherein the amount of data are compared to a predefined amount of data.

17. The video system with adaptive buffering of claim 16, wherein a ratio between the amount of data and the predefined amount of data is generated.

18. The video system with adaptive buffering of claim 17, wherein the content is based on the ratio.

19. The video system with adaptive buffering of claim 18, wherein the ratio is compared to a predetermined ratio.

20. The video system with adaptive buffering of claim 13, wherein allocating further comprises:
measuring an amount of data encoding a picture in the one or more pictures;
measuring another amount of data encoding another picture in the one or more pictures;
generating a ratio based on the amount of data and the another amount of data; and
classifying content for one or more pictures based on the ratio.

21. The video system with adaptive buffering of claim 13, wherein the allocation in the video encoder further comprises:
if the content is a first class, more data is allocated to an independently coded picture and less data is allocated to a dependently coded picture; and
if the content is a second class, less data is allocated to an independently coded picture and more data is allocated to a dependently coded picture.

22. The video system with adaptive buffering of claim 13, wherein the video encoder further comprises:
varying a quantization step size in the encoding of a picture in the another one or more pictures.

23. The video system with adaptive buffering of claim 22, wherein varying further comprises:
increasing the quantization step size of the picture if the content is a first class and the picture is dependently coded; and
decreasing the quantization step size of the picture if the content is a second class and the picture is dependently coded.

24. The video system with adaptive buffering of claim 13, wherein the content is one of a group of classes consisting of static, pseudo-static, slow motion, and fast motion.

25. A circuit, comprising a processor, and a memory connected to the processor, the memory storing a plurality of instructions executable by the processor, wherein execution of said instructions causes:
classifying content for one or more pictures; and
allocating amounts of data for encoding another one or more pictures based on the content of the one or more pictures, wherein the another one or more pictures follow the one or more pictures.

26. The circuit of claim 25, wherein the one or more pictures include:
an independently coded picture; and
a dependently coded picture.

27. The circuit of claim 25, wherein classifying content comprises:
measuring an amount of data encoding one or more pictures.

28. The circuit of claim 27, wherein classifying content comprises:
comparing the amount of data to a predefined amount of data.

29. The circuit of claim 28, wherein comparing comprises:
generating a ratio between the amount of data and the predefined amount of data.

30. The circuit of claim 29, wherein the content is based on the ratio.

31. The circuit of claim 30, wherein the ratio is compared to a predetermined ratio.

32. The circuit of claim 25, wherein allocating further comprises:
measuring an amount of data encoding a picture in the one or more pictures;
measuring another amount of data encoding another picture in the one or more pictures;
generating a ratio based on the amount of data and the another amount of data; and
classifying content for one or more pictures based on the ratio.

33. The circuit of claim 25, wherein allocating further comprises:
if the content is a first class, more data is allocated to an independently coded picture and less data is allocated to a dependently coded picture; and
if the content is a second class, less data is allocated to an independently coded picture and more data is allocated to a dependently coded picture.

34. The circuit of claim 25, wherein allocating comprises:
varying a quantization step size in the encoding of a picture in the another one or more pictures.

35. The circuit of claim 34, wherein varying further comprises:
increasing the quantization step size of the picture if the content is a first class and the picture is dependently coded; and
decreasing the quantization step size of the picture if the content is a second class and the picture is dependently coded.

36. The circuit of claim 25, wherein the content is one of a group of classes consisting of slow motion, fast motion, static, and pseudo-static.
